(19) United States
(12) Patent Application Publication
(10) Pub. No.: US 2009/0250839 A1
(43) Pub. Date: Oct. 8, 2009

(54) Method of preparing an object for submerged sonar inspection

(75) Inventors: Poul A. Andersen, Flaktveit (NO); Erik Eknes, Soreidgrend (NO); Rolf Kahrs Hansen, Bergen (NO)

Correspondence Address: Rodney T. Hodgson, Ph.D., 822 Pinesbridge Rd, Ossining, NY, 34113, US

(73) Assignee: Coda Octopus Group, Inc., New York, NY (US)

(21) Appl. No.: 12/061,298

(22) Filed: Apr. 2, 2008

(51) Int. Cl. B29C 39/00; B29C 59/02; B05D 5/00; B22D 25/02

(52) U.S. Cl. 264/293; 264/299; 156/60; 164/47

(57) ABSTRACT

Objects which are to be inspected by sonar imaging when they are submerged are coated with or formed with a surface which is a non-specular sonar reflector.

### RELATED PATENTS AND APPLICATIONS

U.S. Pat. No. 6,438,071, issued to Hansen, et al. on Aug. 20, 2002, and entitled “Method for producing a 3D image”; and U.S. patent applications Ser. No. 11/504826 filed Aug. 15, 2006; Ser. No. 11/676,427 filed Feb. 19, 2007; and Ser. No. 11/760417 filed 8 Jun. 2007 are related to the present application. The above identified patents and patent applications are assigned to the assignee of the present invention and are incorporated herein by reference in their entirety including incorporated material.

### FIELD OF THE INVENTION

The field of the invention is the field of sonar imaging of submerged objects.

### OBJECTS OF THE INVENTION

It is an object of the invention to improve the sonar imaging of submerged objects.

It is an object of the invention to cover sonar specularly reflecting surfaces of submerged objects with non-specular sonar scattering surfaces.

It is an object of the invention to provide methods of construction of objects which are to be submerged to improve sonar images of the objects.

### SUMMARY OF THE INVENTION

Surfaces of objects which are to be submerged or are submerged are treated or constructed to have a sonar non-specular scattering characteristic, which enhances sonar imaging inspection of such surfaces.

### BRIEF DESCRIPTION OF THE DRAWINGS

FIG. 1 is a sketch of a prior art sonar inspection system.

FIG. 2 is a sketch of ray tracing of sonar waves incident on a submerged sonar specular reflecting surface.

FIG. 3 is a sketch of ray tracing of sonar waves incident on a submerged sonar non-specular reflecting surface.

FIG. 4A is a sonar image of a section of metal pipe.

FIG. 4B is a sonar image of a section of metal pipe covered with 80 grit sandpaper.

FIG. 4C is a sonar image of a section of metal pipe covered with 180 grit sandpaper.

FIG. 5 is a sketch of a prior art form for forming concrete.

FIG. 6 is a sketch of the form of the invention for forming concrete.

FIG. 7 is a sketch of a form of the invention for forming concrete.

FIG. 8 is a sketch of a material for applying to the surface of a submerged object.

### DETAILED DESCRIPTION OF THE INVENTION

Sonar imaging of objects submerged in a fluid is important where the fluid does not transmit light and/or scatters light. Objects such as oil drilling rigs, pipelines, bridge abutments, pilings, breakwaters, etc are subject to damage and wear, and must be inspected regularly. Unfortunately, many such objects are difficult to image with sonar.

FIG. 1 shows a typical sonar imaging system where a vessel 10 floats on the surface 11 of the sea. A sound navigation and ranging (SONAR) receiver 12 is attached to the bottom of the vessel, or alternatively may be strung by a cable from the vessel, or alternatively may be in a remotely operated vehicle (ROV) which sends data to the vessel. The vessel may be a surface vessel as shown, a submarine, or an independently operating ROV.

A single sonar pulse is shown as a wave front 13 propagating from a sonar transmitter attached to the vessel 10. Typically, the pulse would be very short, and the sound energy would be concentrated in a narrow region around the outgoing line shown as a front 13. The sonar pulse could spread out very broadly, as shown, or could be concentrated as a directed beam by suitable use of multiple phased sonar transmitters.

FIG. 1 shows an object 14 suspended above the seabed 15. Sound waves 16 and 17 are shown schematically reflected from surfaces of the object and the seabed. The reflected sound waves are received at the sonar receiver 12. If the receiver 12 is a multielement receiver, the direction from which reflected waves come and the range of the object or the seabed can be calculated. Note that the sent out sonar pulse 13 can be generated using a sonar pulse generator which is either near to or separated from the receiver 12. In particular, a sonar pulse generator may be in an ROV, in a fixed position with respect to the seabed, or in any other fixed or movable position with respect to the sonar receiver 12.

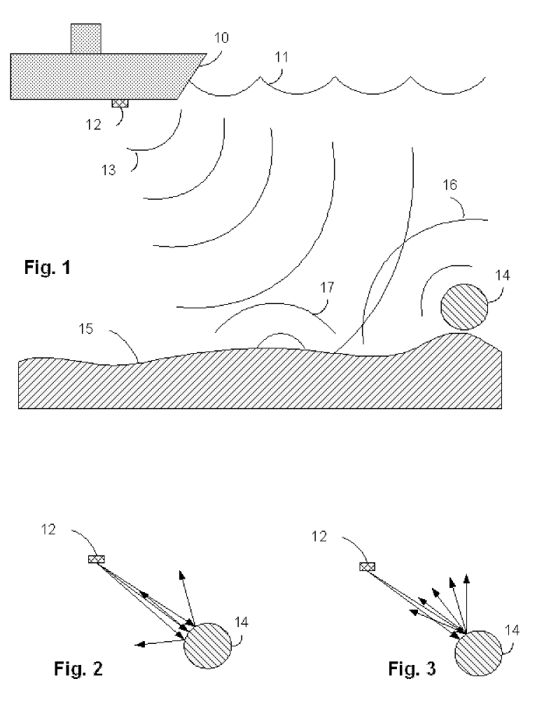

FIG. 2 shows a sketch of an ultrasonic wave, here shown by ray tracing familiar in optical ray tracing, bouncing off the surface of a section of metal pipe represented in cross section where the surface has a specular reflection. The sound waves reaching the surface are bounced from the surface in a direction where the angle of incidence of the sound waves equals the angle of reflection. Sound waves impinging normally on to the surface are scattered back towards the source of the sound waves, which is generally quite close to the sonar image receiver. However, little energy is sent towards the receiver from other parts of the pipe. Thus, the pipe looks like a bright line on the image receiver, and the signal from the sloping sides of the pipe is swamped by the signal from the perpendicular region of the surface of the pipe which is perpendicular to the incoming sonar waves.

FIG. 3 shows a sketch of the system of the invention, where the surface of the pipe has been modified or manufactured to scatter sound waves in a non specular fashion. Now, energy is returned in the direction of the image receiver from the sides of the pipe as well as the section of the pipe which is perpendicular to the impinging sound waves. The pipe diameter, pipe imperfections, etc are much better imaged.

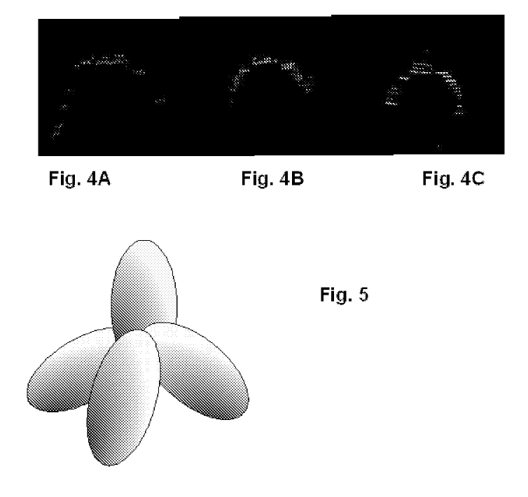

The surface of the pipe must be rough on some scale consistent with the wavelength of the ultrasonic waves impinging on the pipe. The inventors have little data on the ultrasonic scattering data of different surfaces. Such data may be discovered by ordinary experimentation by one of skill in the art. For example, FIGS. 4A, 4B, and 4C show images of a 50 cm long section of Aluminum pipe 1 meter in diameter with a bare surface, with a surface covered with sheets of 40 grit sandpaper, and with the surface covered with 180 grit sandpaper.

With the bare surface of FIG. 4A, we can detect the top of the cylinder (perpendicular) and hardly anything else. There is at least 40 dB contrast between the strongest part and other (weak) echoes.

With the surface covered with 180 grit sand paper of FIG. 4B, we can detect the top of the cylinder (perpendicular) as well as the curvature. There is about 30 dB contrast between the strongest part and other echoes.

With the surface covered with 80 grit sand paper of FIG. 4C, we can detect the top of the cylinder (perpendicular) and see the curvature more clearly. There is about 20 dB contrast between the strongest part and other echoes.

We disclose that wrapping a steel pipe with a tape or covering which has a significant non specular scattering component at the wavelengths of the sonar inspection system used significantly increases the quality of imaging of the pipe. We disclose that manufacturing the pipe or other submerged object to have a rough enough surface for sonar imaging would significantly increases the quality of sonar imaging of the submerged object. For example, steel pipes are often coated with steel reinforced cement or concrete to hinder corrosion of the pipe. Typically, the concrete coating is 5 cm thick, and the surface is quite smooth. Forms for casting the concrete or cement skin around the pipe are proposed which are made with a rough interior surface, the texture of which will transfer to the exterior surface of the concrete covered metal pipe. In fact, metal pipes which are cast by centrifugal casting may be cast in molds which have rough interior surfaces, which will then transfer a rough surface to the metal pipe itself. Metal objects underwater may be formed from thin sheets which are stamped with a pattern of sufficient roughness to scatter sonar waves in a non specular fashion.

Many objects are formed from concrete, which is either poured underwater or poured into forms in air and then placed in position underwater. When placing such objects, it is very helpful to have sonar imaging to assist in the placement.

Typically, forms for cylindrical pilings etc are made from a tube of rolled paper which is quite smooth both inside and outside. Normally the form is not removed from the cylinder before the cylinder is submerged. In order to enhance the sonar imaging of the form, the outer surface of the form should be made rough. For example, sawdust or some other particulate material may be added to the last layer of paper forming the tube, or may be sprayed on with an adhesive substance. The same material may be used on the inside of the tube to texture the concrete if the tube material disappears with time after the piling is placed.

Large concrete blocks are used to form breakwaters and stabilize banks. These blocks may also be cast using forms which are roughened on the inside. Normally, forms for pouring concrete are made from smooth plywood, and the wood is oiled to aid in separating the forms from the concrete. In the method of the invention, the plywood is rolled with a metal roller or hammered with a patterned hammer which makes indentations in the wood. The pattern of then indentations transfers to the cast concrete, and increases the image quality of underwater imaging of the resulting concrete object. In the alternative, polyethlene spheres or a rough polyethlene sheet may be glued to the inside of the forms before the concrete is poured. When the concrete hardens, the polyethlene aids in the separation. Polyethylene adhering to the concrete is essentially transparent to the inpinging sound waves in water, and the rough concrete surface produced is an effective non-specular scattering surface for sound waves.

Large numbers of multi-ton concrete objects called tetrapods sketched in FIG. 5 are used as breakwater objects. These objects must be placed in interlocking positions, and the placement is controlled by ultrasound imaging. The forms used to cast the tetrapods are steel. The insides of the forms are then stamped to give a rough texture to the tetrapod surfaces to aid in the sonar imaging.

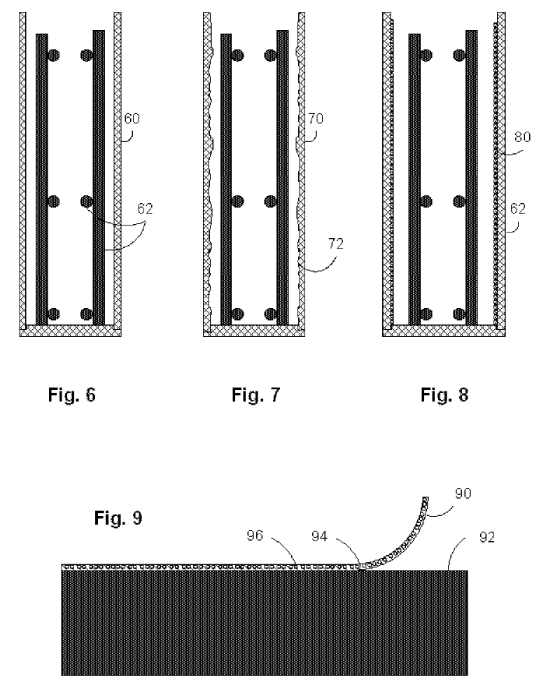

FIG. 6 shows a prior art form for casting a reinforced concrete pile (or cylinder). A form 60 surrounds reinforcing steel 62 (rebar). The form is generally made of paper material, and may be remove or may be retained when the pile is driven into the ground under water. FIG. 7 shows a form of the invention where the inside surface 72 of the form 70 is textured to transfer a sonar non specular surface texture to the resulting concrete after the concrete is poured, set, and the form removed. In the case that the form is retained when the pile is driven, the outside of the form may be textured, or both the inside and outside of the form may be textured.

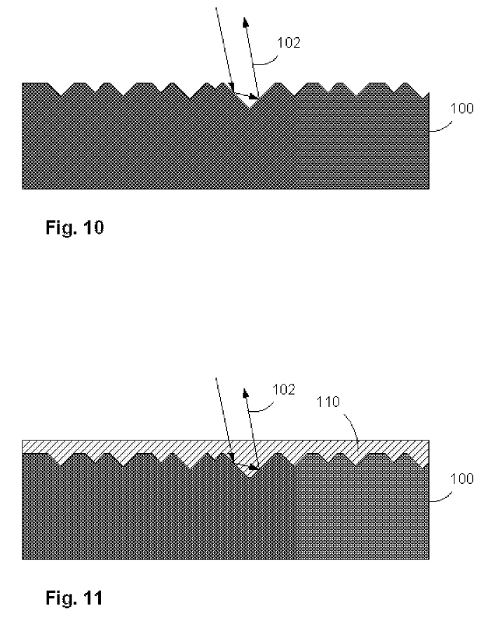

FIG. 8 shows an alternative embodiment of the invention, wherein a “bubble wrap” or textured foam layer 80 is placed around the inside of the form. The bubbles of course must be strong enough to stand the hydrostatic pressure of the liquid concrete, but may shear when the set concrete is forced from the form 60.

FIG. 9 shows an embodiment of the invention, where a tape 90 is attached to the surface of an object 92. The tape 90 may be a composite material, where a matrix 94 has an included material 96. The matrix 94 and the included material should have as much difference in acoustic impedance as possible to allow the maximum non specular component of sonar scattering from the object.

FIG. 10 shows an object 100 with impressed corner cube reflectors. Sound waves 102 are shown being scattered back in the direction of the incoming beam.

FIG. 11 shows the same surface modification as that of FIG. 10, wherein a material covers the corner cube reflectors. The material 110 should have the same acoustic impedance as the surrounding fluid. Polyethylene is one such material which has little reflection of sonar imaging radiation.

Obviously, many modifications and variations of the present invention are possible in light of the above teachings. It is therefore to be understood that, within the scope of the appended claims, the invention may be practiced otherwise than as specifically described.

We claim:

1. A method of preparing an object for submerged sonar inspection, comprising;
attaching a sonar scattering material to a sonar specular reflecting surface of the object.

2. The method of claim 1, wherein the sonar scattering material comprises a composite material.

3. The method of claim 2, wherein the composite material has regions of differing density.

4. The method of claim 3, wherein the composite material is a material embedded with hollow spheres, the hollow spheres filled with gas.

5. The method of claim 4, wherein the hollow spheres have glass walls.

6. The method of claim 5, wherein the gas is a high pressure gas.

7. The method of claim 2, wherein the composite material is a material embedded with solid spheres.

8. The method of claim 1, wherein the sonar scattering material has a textured surface.

9. The method of claim 8, wherein the textured surface is a surface having impressed corner cube reflectors.

10. The method of claim 1, wherein the sonar scattering material is a composite material comprising a matrix of material having a density matching the density of liquid in which the object is immersed with material embedded in the matrix, the embedded material having a density greatly different from the matrix material.

11. A method of preparing an object for submerged sonar inspection, comprising;
constructing the object with a construction method which leaves the surface of the object with a scattering surface which scatters sonar inspection sound waves.

12. The method of claim 11, wherein object is molded in a mold.

13. The method of claim 11, wherein object is constructed by pouring concrete into a form,
wherein at least a part of the interior surface of the form has a texture, and wherein the texture transferred to the surface of the cured concrete object formed in the molding process forms a surface which scatters sonar inspection sound waves.

14. The method of claim 11, wherein object is constructed by pouring metal into a mold,
wherein at least a part of the interior surface of the mold has a texture, and wherein the texture transferred to the surface of the solidified object formed in the molding process forms a surface which scatters sonar inspection sound waves.

15. The method of claim 11, wherein the surface of the object is formed from a stamped sheet.

16. The method of claim 15, wherein the surface of the object is formed from a corrugated sheet.

17. The method of claim 15, wherein the surface of the object is formed from an egg carton patterned sheet.

18. The method of claim 15, wherein the surface of the object is formed from stamped corner cube reflector sheet.
